(19) United States
(12) Patent Application Publication
(10) Pub. No.: US 2010/0150577 A1
(43) Pub. Date: Jun. 17, 2010

(54) Communication System and Method With Signal Constellation

(76) Inventors: Rene'-Jean Essiambre, Red Bank, NJ (US); Gerard J. Foschini, Sayreville, NJ (US); Gerhard Guenter Theodor Kramer, Chatham, NJ (US); Peter J. Winzer, Aberdeen, NJ (US)

Correspondence Address: Docket Administrator - Room 3D-201E;Alcatel-Lucent USA Inc., 600-700 Mountain Avenue, Murray Hill, NJ, 07974, US

(21) Appl. No.: 12/639,750

(22) Filed: Dec. 16, 2009

Related U.S. Application Data
(60) Provisional application No. 61/201,861, filed on Dec. 16, 2008.

(51) Int. Cl. H04L 27/20; H04B 10/04

(52) U.S. Cl. 398/188; 375/308

(57) ABSTRACT

An example method includes modulating an optical signal using a Phase Shift Keying (PSK) signal constellation, wherein signal points of the PSK signal constellation are located on at least two rings. The first ring has a first radius r1 and a second ring has a second radius r2, wherein the first radius and second radius differ, and wherein the signal points are not located on a regular n-dimension lattice, where n is an integer. The regular n-dimension lattice is formed from a minimum number of lines parallel to an axis for each of the n-dimensions that connect ones of the signal points of the PSK signal constellation on either side of an origin of the axis. The second radius may be greater than the first radius, with the second radius a non-integer multiple of the first ring radius.

### RELATED APPLICATIONS

This application claims priority to Provisional Application No. 61/201,861, filed Dec. 16, 2008, the entirety of which is hereby incorporated by reference.

### BACKGROUND

1. Field of the Invention

The inventions described herein relate to optical communication equipment and, more specifically but not exclusively, to equipment that enables modulation and demodulation of signals using signal constellations for the reception and transmission of information.

2. Description of the Related Art

Information is typically modulated for transmission. Modulation is the process of transforming a message signal for ease of use and usually involves varying one waveform in relation to another waveform. In telecommunications, modulation is used to convey a message. For example, the amplitude (e.g., volume), phase (e.g., timing) and frequency (e.g., pitch) of a signal may be varied to convey information.

A constellation diagram is a representation of a signal modulated by a digital modulation scheme. For example, a signal may be modulated according to Quadrature Amplitude Modulation (QAM) or Phase-Shift Keying (PSK) in additional to a variety of other modulation schemes. In a constellation diagram, the signal is displayed as a two-dimensional scatter diagram in the complex plane, which may be thought of as a representation of the set of possible sampled matched filter output values. Accordingly, a signal constellation represents the possible symbols that may be selected by a given modulation scheme as points in the complex plane. Measured constellation diagrams for received signals that have been modulated can be used to recognize the type of interference and distortion in the received a signal.

By representing a transmitted symbol as a complex number and modulating a cosine and sine carrier signal with the real and imaginary parts respectively, the symbol can be sent with two carriers on the same frequency. These two carriers are often referred to as quadrature carriers and may be independently demodulated by a coherent detector. Use of two independently modulated carriers is the foundation of quadrature modulation. In pure phase modulation, the phase of the modulating symbol is the phase of the carrier itself.

The symbols in the signal constellation can be visualized as points in the complex plane. The real and imaginary axes are often called the in-phase, or I-axis and the quadrature, or Q-axis. Plotting several symbols in a scatter diagram produces the constellation diagram. The points on a constellation diagram may be referred to as constellation points or signal points and are a set of modulation symbols which comprise the modulation alphabet. The term constellation diagram may also be used to refer to a diagram of the ideal positions of signal points in the signal constellation of a modulation scheme. Thus, the constellation is a representation of all symbols of the modulation scheme.

Upon reception of a signal, a demodulator examines the received symbol, which may have been corrupted by the channel or the receiver (e.g. by additive white noise, distortion, phase noise or interference). According to, for example, maximum likelihood detection in the presence of additive Gaussian noise, the demodulator selects the point on the constellation diagram which is closest (in a Euclidean distance sense) to that of the received symbol as the estimate of the signal that was actually transmitted. A constellation diagram allows a straightforward visualization of this process; a receiver recognizes the received symbol as an arbitrary point in the I-Q plane and then decides that the transmitted symbol is whichever constellation point is closest to the received signal. Thus, the received signal will be demodulated incorrectly if corruption has caused the received symbol to move closer to another constellation point than the one actually transmitted.

For the purpose of analyzing received signal quality, corruption may be evident in the constellation diagram. For example, Gaussian noise may appear as fuzzy constellation points; non-coherent single frequency interference may appear as circular constellation points; phase noise may appear as rotationally spreading constellation points; and amplitude compression may cause the corner points to move towards the center of the constellation.

Current transmission systems are limited in reach due to signal corruption and the inability to demodulate a received signal correctly if corruption has caused the received symbol to move closer to another constellation point than the one transmitted.

### SUMMARY

When corruption (e.g., noise) causes a received symbol to move closer to another constellation point than the one transmitted, an optical communication system is unable to demodulate a received signal correctly. As a result of such corruption and the inability to demodulate a received signal correctly, current communication systems are limited in reach.

An optimum constellation for the detection of signals corrupted by noise is given by a bidimensional Gaussian distribution of symbols in the complex plane describing the complex symbols. For the discrete amplitude case, the bidimensional Gaussian can be approximated by a constellation in rings of equal frequencies and equally spaced in amplitude. Conventional constraints for multiple ring constellations include: ring radii that are integer multiples of the inner ring radius; and equal frequency of occupation on each ring.

Embodiments described herein move away from the constant amplitude ring constellations for improved transmission at high signal power in optical fibers. The signal constellations provided by the described embodiments lead to a reduction in the effects of nonlinearities, allowing extension of the reach of fiber-optic communication systems. Systems, apparatuses and methods are provided that extend the distance of transmission, which is especially critical for next generation of highly spectrally-efficient systems. One example of a family of optimum constellations that minimize signal distortions from fiber nonlinearities is given by constellations with points located much closer in amplitude than the uniform ring constellation. Constellations where symbols located near the origin are sparse or absent also provide the improved nonlinear transmission performance.

Some embodiments provided herein are configured to reduce errors that would be otherwise induced by nonlinear effects in data transmitted via optical Quadrature Phase Shift Keying (QPSK) modulation schemes. In such schemes, nonlinear optical effects have a tendency to distort phase data carried via in-phase and quadrature phase components.

A method of shaping an optical signal using a signal constellation is provided. The method includes modulating the optical signal using a Phase Shift Keying (QPSK) signal constellation. Signal points of the PSK signal constellation are located on at least two rings. The first ring has a first radius r1 and the second ring has a second radius r2. The first radius and second radius differ, and the signal points are not located on a regular n-dimension lattice, where n is an integer.

A regular n-dimension lattice is formed from a minimum number of lines parallel to an axis for each of the n-dimensions that connect ones of the signal points of the PSK signal constellation on either side of an origin of the axis. In a regular n-dimensional lattice, signal points are located at intersection points of the lattice constructed of the minimum number of lines parallel to the axis that intersect all signal points.

In one embodiment, the second radius is greater than the first radius, with the second radius being a non-integer multiple of the first ring radius. In another embodiment, the signal points are located on two rings and wherein the signal points are not located on a regular two dimensional (2D) rectangular lattice. In another embodiment, the second radius r2 is not an integer multiple of the first radius r1. In a further embodiment, the ratio of the first radius r1 to the second radius r2 is greater than approximately 0.5.

The signal points of the signal constellation may be represented by a component on a plane, the plane having at least one axis, the axis extending from an origin in a first direction and in a second direction, wherein the signal constellation includes at least two signal points, a first point lying in the first direction and a second point lying in the second direction, wherein an amplitude of the first signal point in the first direction is greater than an amplitude of the second signal point in the second direction.

In one embodiment, the signal points form a spiral. For example, the signal points may be located on four rings, with the signal points being not located on a regular two dimensional (2D) rectangular lattice. In another embodiment, signal points of the signal constellation may be represented on a complex plane, the complex plane having an in-phase axis extending in a first direction and in a second direction and the complex plane having an imaginary axis extending in a third direction and in a fourth direction, wherein each signal point has an in-phase component and an imaginary component. In that embodiment, the maximum amplitude of the in-phase component of the signal points in the first direction is greater than maximum amplitude of the in-phase component of the signal point in the second direction; and the maximum amplitude of the quadrature component of the signal points in the third direction is greater than maximum amplitude of the quadrature component of the signal points in the fourth direction.

In another example, the signal points of the signal constellation may be represented on a complex plane, the complex plane having an in-phase axis extending in a first direction and in a second direction and the complex plane having an imaginary axis extending in a third direction and in a fourth direction, wherein each signal point has an in-phase component and an imaginary component, with the maximum amplitude of the signal points in each of the first, second, third, or fourth directions differing.

Embodiments may additionally include receiving the signal to be modulated, transmitting the modulated signal and a combination thereof.

In another embodiment, a method of shaping an optical signal includes modulating the optical signal using a PSK signal constellation having a set of signal points, wherein each of the signal points is represented by a complex number having at least a first component and a second component, wherein a first maximum amplitude of the first component of the set of signal points of the PSK signal constellation differs from a second maximum amplitude of the second component of the set of signal points of the PSK signal constellation.

In another embodiment, a method of shaping an optical signal includes modulating the optical signal using a PSK signal constellation having a plurality of signal points, wherein signal points are represented by a first component along a first axis and a second component along a second axis, wherein a first maximum amplitude of the first component of the plurality of signal points differs from a second maximum amplitude of the second component of the plurality of signal points.

For example, the signal points of the PSK signal constellation may be located on at least one oval in the complex plane. In another example, the signal points of the PSK signal constellation may be located on at least one egg shaped curve in the complex plane.

In one embodiment, an apparatus includes a first encoder configured to receive a binary bitstream, the encoder further configured to encode the binary bitstream by shaping the binary bitstream based on a Phase Shift Keying (PSK) signal constellation, wherein signal points of the PSK signal constellation are located on at least two rings, a first ring having a first radius r1 and a second ring having a second radius r2, wherein the first radius and second radius differ, and wherein the signal points are not located on a regular n-dimension lattice, where n is an integer, the first encoder further configured to modulate the encoded binary bitstream with a carrier.

The apparatus may include a demultiplexer configured to separate the binary bitstream from a signal representing an optical signal to be transmitted. In one embodiment the apparatus includes a receiver adapted to recover data carried by an optical signal. In another embodiment the apparatus is a transmitter for transmitting the modulated signal. In other alternative embodiments, the apparatus may include receiver for decoding the optical signal and be configured for transmitting the modulated signal.

In one embodiment, an apparatus comprises a modulator for modulating an optical signal using a PSK signal constellation having a set of signal points, wherein each of the signal points is represented by a complex number having at least a first component and a second component, wherein a first maximum amplitude of the first component of the set of signal points of the PSK signal constellation differs from a second maximum amplitude of the second component of the set of signal points of the PSK signal constellation.

In another embodiment, an apparatus comprises a modulator for modulating an optical signal using a PSK signal constellation having a plurality of signal points, wherein signal points are represented by a first component along a first axis and a second component along a second axis, wherein a first maximum amplitude of the first component of the plurality of signal points differs from a second maximum amplitude of the second component of the plurality of signal points.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting, and wherein:

FIGS. 1a and 1b qualitatively illustrate how distortions due to nonlinear optical effects can introduce errors during demodulation of 4-Phase Shift Keying (QPSK) signal points;

FIGS. 2a and 2b illustrate an embodiment that may reduce demodulation errors by modulating the in-phase and quadrature phase components of an optical carrier with signals of different amplitude;

FIG. 3 illustrates one embodiment of a signal constellation according to the principles of the invention;

FIG. 4 illustrates an example transmitter structure for Quadrature Phase Shift Keying (QPSK);

FIG. 5 illustrates an example receiver structure for QPSK; and

FIG. 6 is schematic diagram of an example optical transmission system that employs modulation utilizing a signal constellation according to principles of the invention.

### DETAILED DESCRIPTION

Various example embodiments will now be described more fully with reference to the accompanying figures, it being noted that specific structural and functional details disclosed herein are merely representative for purposes of describing example embodiments. Example embodiments may be embodied in many alternate forms and should not be construed as limited to only the embodiments set forth herein.

Throughout the detailed description, the drawings, are illustrative only and are used in order to explain, rather than limit the invention. Although the terms first, second, etc. may be used herein to describe various elements, these elements should not be limited by these term since such terms are only used to distinguish one element from another. For example, a first element could be termed a second element, and, similarly, a second element could be termed a first element, without departing from the scope of example embodiments. As used herein, the term “and” is utilized in the conjunctive and disjunctive senses and includes any and all combinations of one or more of the associated listed items, and the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

A constellation for the detection of signals corrupted by noise may be given by a bidimensional Gaussian distribution of symbols in the complex plane describing the complex symbols. For the discrete amplitude case, the bidimensional Gaussian can be approximated by a constellation in rings of equal frequencies and equally spaced in amplitude. Conventional constraints for multiple ring constellations include: ring radii that are integer multiples of the inner ring radius; and equal frequency of occupation on each ring.

However, corruption (e.g., noise) may cause a received symbol to move closer to another constellation point than the one transmitted. Due to this effect, an optical communication system may be unable to demodulate a received signal correctly and as a result, the reach of the communication system may be limited.

Improved transmission at high signal power in optical fibers may be provided by embodiments that do not employ constant amplitude ring constellations. Signal constellations described herein lead to a reduction in the effects of nonlinearities, allowing extension of the reach of fiber-optic communication systems. Thus, the distance of transmission for such communication systems can be extended, which is especially critical for next generation of highly spectrally-efficient systems. One example of a family of optimum constellations that minimize signal distortions from fiber nonlinearities is given by constellations with points located much closer in amplitude than the uniform ring constellation. Constellations where symbols located near the origin are sparse or absent also provide the improved nonlinear transmission performance.

Some embodiments provided herein are configured to reduce errors that would be otherwise induced by nonlinear effects in data transmitted via optical Quadrature Phase Shift Keying (QPSK) modulation schemes. In such schemes, nonlinear optical effects have a tendency to distort phase data carried via in-phase and quadrature phase components. FIGS. 1a and 1b qualitatively illustrate how distortions due to nonlinear optical effects can introduce errors during demodulation of 4-QPSK signal points. In FIG. 1a, 4-QPSK signal points are illustrated in a complex plane. The signal points are equally spaced in amplitude and shown lying on a unit circle.

The signal points received after transmission are illustrated in FIG. 1b. As shown by the received scatter diagram, the transmitted signals are corrupted due to noise by the channel or the receiver (e.g. by additive white noise, distortion, phase noise or interference) during transmission. Accordingly, the received signal points fall within a band 100. A demodulator examines a received symbol, and determines a corresponding constellation point for the received signal. For example, according to maximum likelihood detection, the demodulator selects the point on the constellation diagram which is closest (in a Eculidean distance sense) to that of the received symbol as the estimate of the signal that was actually transmitted. Demodulation errors occur if the corruption of the received signal is large enough that the demodulator selects a constellation point that is not equivalent to the transmitted signal.

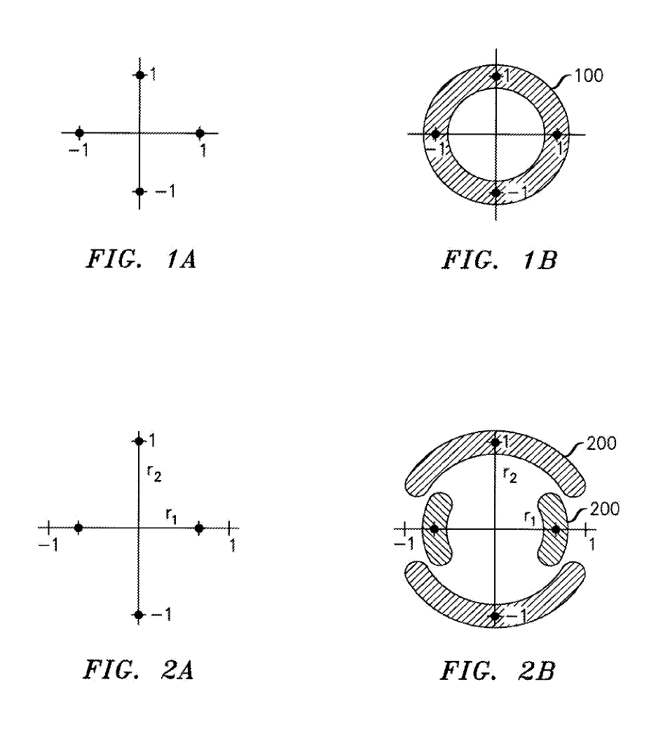

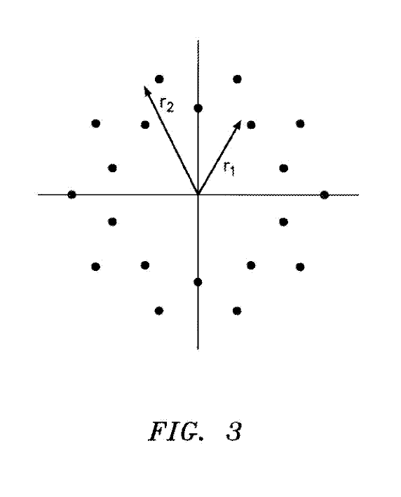

FIGS. 2a and 2b illustrate an embodiment according to the principles of the invention which may result in the reduction of demodulation errors by modulating the in-phase and quadrature phase components of an optical carrier with signals of different amplitude. FIGS. 2a-2b provide an illustration for a specific embodiment in which the constellation has four (4) signal points, but potentially produces a lower error rate than optical 4-QPSK, i.e., in the presences of distortions due to nonlinear optical effects.

As shown in FIG. 2a, signal points of the PSK signal constellation are located on at least two rings, a first ring having a first radius r1 and a second ring having a second radius r2, wherein the first radius and second radius differ, and wherein the signal points are not located on a regular n-dimension lattice, where n is an integer. The signal points are illustrated on a two dimensional plane having two axes.

A regular n-dimension lattice is formed from a minimum number of lines parallel to an axis for each of the n-dimensions that connect ones of the signal points of the PSK signal constellation on either side of an origin of the axis. In a regular n-dimension lattice, signal points are located at intersections points of the lattice and are subject to the constraints that signal points are equally spaced in amplitude.

In one embodiment, the second radius is greater than the first radius, and the second radius is a non-integer multiple of the first ring radius. In another embodiment, the signal points are located on two rings and wherein the signal points are not located on a regular two dimensional (2D) rectangular lattice. In another embodiment, the second radius r2 is not an integer multiple of the first radius r1 (i.e., r2!=m(r1) where m is an integer). As shown in FIG. 2a, the first radius of first ring r1 is less than one (1) whereas the second radius of the second ring R2 is equal to one (1). In a further embodiment, the ratio of the first radius r1 to the second radius r2 is greater than approximately 0.5 in order to have sufficient spacing of signal points in the constellation so as to permit demodulation in the presence of signal corruption.

The signal points of the signal constellation may be represented by a component on a plane, the plane having at least one axis, the axis extending from an origin in a first direction and in a second direction, wherein the signal constellation includes at least two signal points, a first point lying in the first direction and a second point lying in the second direction, wherein an amplitude of the first signal point in the first direction is greater than an amplitude of the second signal point in the second direction. That is; the amplitude of the first signal point in the positive direction on an axis may a first value while the amplitude of the second signal point in the negative direction on that same axis may be a different value.

The received signal points, shown with nonlinear distortion of the transmitted signal points are illustrated in FIG. 2b. As shown by the received scatter diagram, the transmitted signals are corrupted due to noise by the channel or the receiver (e.g. by additive white noise, distortion, phase noise or interference) during transmission. Accordingly, the received signal points fall within bands 200.

FIG. 3 illustrates one embodiment of a signal constellation generated according to the principles of the invention. The illustrated signal points fall on two rings. The first ring has a radius r1. The second ring has a radius r2. The second radius is greater than the first radius and is a non-integer multiple of the first ring radius. In one embodiment, the signal constellations has 2 rings with a ratio of amplitude of inner to outer ring >0.5. Advantageously, the signal constellation provided according to this embodiment may increase transparency of optical networks and may allow a reduction in the need for Raman amplification in some systems.

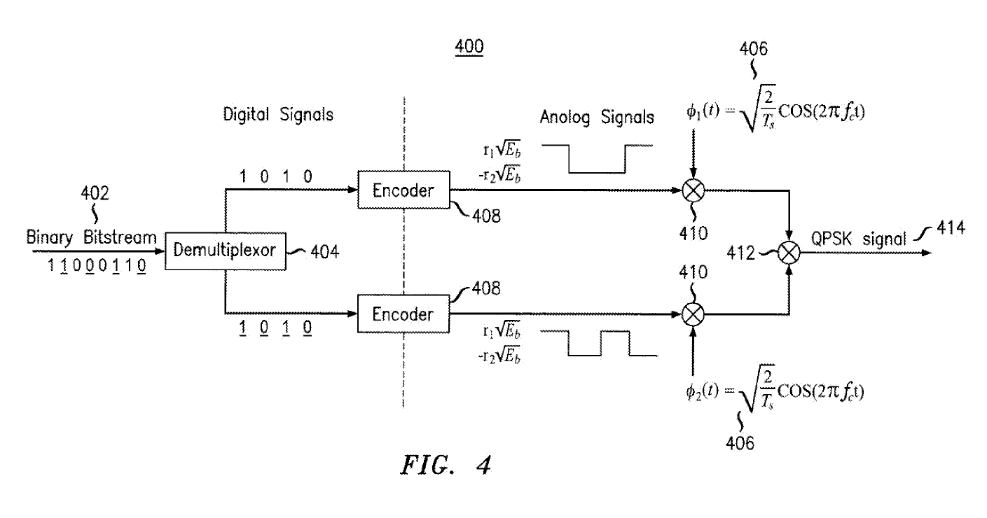

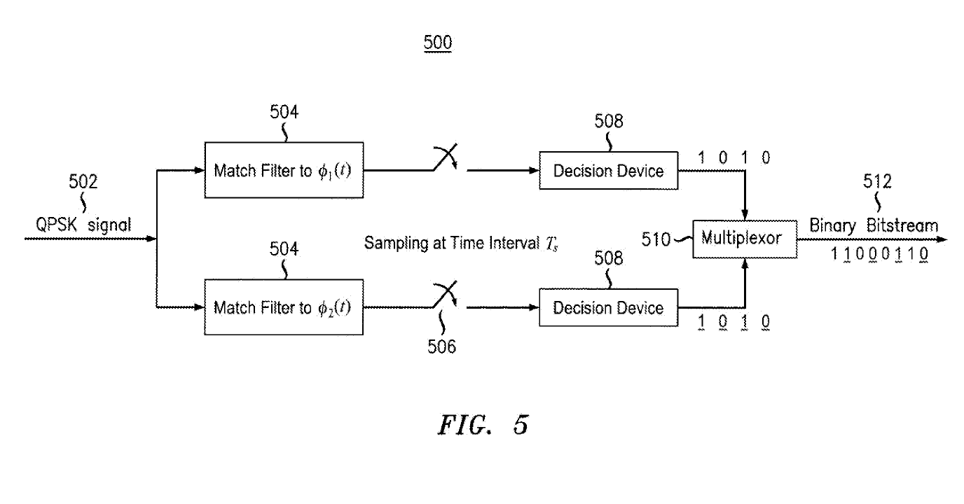

FIG. 4 illustrates an example transmitter structure 400 for QPSK. The binary data stream 402 is split by a demultiplexor 404 into the in-phase and quadrature-phase components. Branches of the binary bit stream are then separately modulated onto two orthogonal basis functions 406. The modulation is accomplished by an encoder which receives a branch of the binary bitstream and encode the branch of the binary bitstream by shaping the binary bitstream based on a Phase Shift Keying (PSK) signal constellation, wherein signal points of the PSK signal constellation are located on at least two rings, a first ring having a first radius r1 and a second ring having a second radius r2, wherein the first radius and second radius differ, and wherein the signal points are not located on a regular n-dimension lattice, where n is an integer. The encoder further includes a multiplier 410 which varies the encoded binary bitstream with orthogonal basis function 406.

In this illustrated implementation, two sinusoids are used as the orthogonal basis functions. Afterwards, the two signals for the branches are superimposed by combiner 412, and the resulting signal is the QPSK signal 414. Note the use of polar non-return-to-zero encoding. These encoders can be placed before for binary data source, but have been placed after to illustrate the conceptual difference between digital and analog signals involved with digital modulation.

FIG. 5 illustrates an example receiver structure 500 for QPSK. QPSK signal 502 is delivered to matched filters 504. The matched filters correspond to the two orthogonal basis functions of the corresponding transmitter. The matched filters can be replaced with correlators. After filtering, the signal for each component is sampled at a time interval Ts 506. The sampled signal for each component is provide to a detection device 508. Each detection device uses a reference threshold value to determine whether a one (1) or zero (0) is detected. The detected signal for each component is mixed by multiplexer 5510 to create the resultant recovered binary bitstream 512.

Constellation shaping is utilized to address phase noise due to nonlinearities, polarization noise or a combination of both. The shaping process attempts to minimize effects of nonlinearities and noise. The signal constellation provided may be use to modulate a single signal or for each of multiple signals. For example, the signal constellation may be utilized in an OFDM scheme

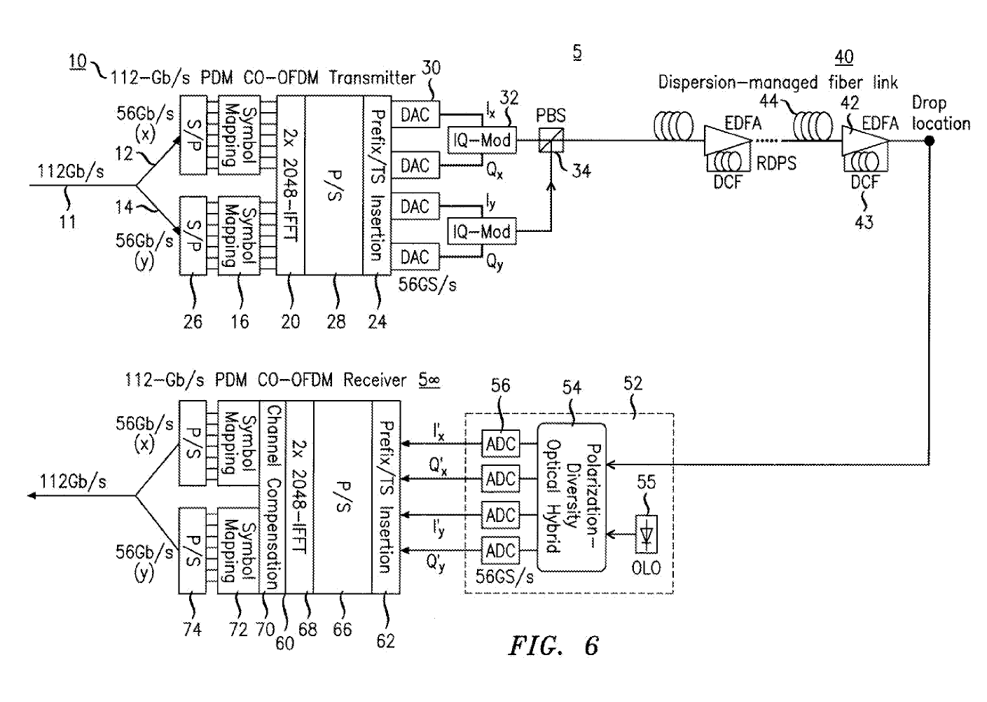

FIG. 6 is schematic diagram of an exemplary optical transmission system that employs modulation utilizing a signal constellation according the modulation described herein. In the exemplary system 5, a 112-Gb/s PDM-OFDM transmitter 10 is connected via a dispersion managed transmission link 40 to a 112-Gb/s PDM-OFDM receiver setup 50. Other data rate signals can be handled in a similar manner.

At the transmitter 10, the original 112-Gb/s data 11 are first divided into x- and y-polarization branches 12 and 14 each of which is mapped by symbol mapping module 16 onto frequency subcarriers with modulation according to the PSK scheme of the invention, which, are transferred to the time domain by an Inverse Fast Fourier Transform (IFFT) supplied by IFFT module 20. For example, each polarization branch 12 or 14 may be mapped onto twelve-hundred-eighty (1280) frequency subcarriers with phase shift keying (PSK) modulation as has been described herein, which, together with sixteen (16) pilot subcarriers, are transferred to the time domain by an IFFT of size two-thousand-forty-right (2048) with a filling ratio of approximately sixty-three percent (˜63%). The sixteen (16) pilot subcarriers may be distributed uniformly in the frequency domain.

A cyclic prefix may be inserted by prefix/TS insertion extension module 24 to accommodate inter-symbol interference which may be caused by chromatic dispersion (CD) and polarization-mode dispersion (PMD) in the optical transmission link 40.

The IFFT algorithm is organized on a symbol basis requiring a parallelization via a serial-to-parallel module 26 of input data before application of the algorithm and a serialization via parallel-to-serial module 28 afterwards. After parallelization of data in the transmitter a coder is required transferring a binary on-off coding into, for example, a four level phase modulation signal with the phase values of [π/4, 3π/4, 5π/4, 7π/4].

The superposition of multiple frequency carriers leads to an analog signal in the time domain. Hence a digital-to-analog converter (DAC) 30 is required after serialization in the transmitter and opposite analog-to-digital converter (ADC) 56 in the receiver 50 in front of the digital signal processing. The DAC operates at a given sampling rate. For example, after the time-domain samples corresponding to the real and imaginary parts of one polarization component of the PDM-OFDM signal are serialized they may be converted by two 56-GS/s DACs.

The two analog waveforms converted by the two DACs are used to drive an I/Q modulator 32 to form one polarization component of the PDM-OFDM signal, which is then combined with the other polarization component of the PDM-OFDM signal (generated similarly) by a polarization beam splitter (PBS) 34 to form the original optical PDM-OFDM signal. Each of the two IQ modulators 32 are connected to a laser 31. Prefix/training symbol insertion module 24 may also insert training symbols for use in channel estimation.

The orthogonal frequency-division multiplexed (OFDM) signal is carried via a transmission link 40 to a 112-Gb/s PDM-OFDM receiver 50. The optical link may be an inline dispersion compensated transmission link and include a number of Erbium-doped fiber amplifiers (EDFA) 42 and corresponding inline dispersion compensation modules made of dispersion compensating fibers (DCF) 43 for amplifying and compensating the signal during its transport over a number of fiber spans 44.

At the receiver 50, digital coherent detection with polarization diversity is used to sample the fields of two orthogonal components of the received optical signal at the receiver front end 52. Thus, the receiver front end includes Polarization Diversity Optical Hybrid 54, an optical local oscillator 55 and analog-to-digital converters (ADC) 56. The ADC operates at a predetermined sampling rate, which can be the same as that of the DAC 30.

Symbol synchronization is then performed, and training symbols are extracted for channel estimation that minimizes the detrimental effects such as PMD and CD on each OFDM subcarrier at the receiver digital signal processor (DSP) 60. The receiver DSP includes modules for prefix/training symbol removal 62, parallel-to-serial conversion 66, Fast Fourier Transform (FFT) 68, channel compensation 70, symbol mapping 72, and serial-to-parallel conversion 74 leading to a reconstruction of the original data provided to the transmitter.

A variety of the functions described above with respect to the exemplary method are readily carried out by special or general purpose digital information processing devices acting under appropriate instructions embodied, e.g., in software, firmware, hardware or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module. For example, functional modules of the DSP and the other logic circuits can be implemented as an ASIC (Application Specific Integrated Circuit) constructed with semiconductor technology and may also be implemented with FPGA (Field Programmable Gate Arrays) or any other hardware blocks.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Unless explicitly stated otherwise, each numerical value and range should be interpreted as being approximate as if the word “about” or “approximately” preceded the value of the value or range.

Although specific embodiments were described herein, the scope of the invention is not limited to those specific embodiments. It will be understood that various changes in the details, materials, and arrangements of the parts which have been described and illustrated in order to explain the nature of this invention may be made by those skilled in the art without departing from the scope of the invention as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

What is claimed is:

1. A method of shaping an optical signal, the method comprising:
modulating the optical signal using a Phase Shift Keying (PS K) signal constellation, wherein signal points of the PSK signal constellation are located on at least two rings, a first ring having a first radius r1 and a second ring having a second radius r2, wherein the first radius and second radius differ, and wherein the signal points are not located on a regular n-dimensional lattice, where n is an integer.

2. The method of claim 1 wherein the regular n-dimension lattice is formed from a minimum number of lines parallel to an axis for each of the n-dimensions that connect ones of the signal points of the PSK signal constellation on either side of an origin of the axis.

3. The method of claim 1 wherein the second radius is greater than the first radius, and wherein the second radius a non-integer multiple of the first ring radius.

3. The method of claim 1 wherein the signal points are located on two rings and wherein the signal points are not located on a regular two dimensional (2D) rectangular lattice.

4. The method of claim 1 wherein the second radius r2 is not an integer multiple of the first radius r1.

5. The method of claim 1 wherein the ratio of the first radius r1 to the second radius r2 is greater than approximately 0.5.

6. The method of claim 1 wherein the signal points of the signal constellation may be represented by a component on a plane, the plane having at least one axis, the axis extending from an origin in a first direction and in a second direction, wherein the signal constellation includes at least two signal points, a first point lying in the first direction and a second point lying in the second direction, wherein an amplitude of the first signal point in the first direction is greater than an amplitude of the second signal point in the second direction.

7. The method of claim 1 wherein the signal points form a spiral.

8. The method of claim 1 wherein the signal points are located on four rings and wherein the signal points are not located on a regular two dimensional (2D) rectangular lattice.

9. The method of claim 1 wherein the signal points of the signal constellation may be represented on a complex plane, the complex plane having an in-phase axis extending in a first direction and in a second direction and the complex plane having an imaginary axis extending in a third direction and in a fourth direction, wherein each signal point has an in-phase component and an imaginary component,
wherein a maximum amplitude of the in-phase component of the signal points in the first direction is greater than a maximum amplitude of the in-phase component of the signal point in the second direction,
wherein a maximum amplitude of the quadrature component of the signal points in the third direction is greater than a maximum amplitude of the quadrature component of the signal points in the fourth direction,

10. The method of claim 1 wherein the signal points of the signal constellation may be represented on a complex plane, the complex plane having an in-phase axis extending in a first direction and in a second direction and the complex plane having an imaginary axis extending in a third direction and in a fourth direction, wherein each signal point has an in-phase component and an imaginary component,
wherein a maximum amplitude of the signal points in each of the first, second, third, or fourth directions differs.

11. The method of claim 1 further comprising:
receiving the optical signal.

12. The method of claim 1 further comprising:
transmitting the modulated signal.

13. A method of shaping an optical signal, the method comprising:
modulating the optical signal using a Phase Shift Keying (PSK) signal constellation having a set of signal points, wherein each of the signal points is represented by a complex number having at least a first component and a second component, wherein a first maximum amplitude of the first component of the set of signal points of the PSK signal constellation differs from a second maximum amplitude of the second component of the set of signal points of the PSK signal constellation.

14. An apparatus comprising:
a first encoder configured to receive a bitstream, the encoder further configured to encode the bitstream by shaping the bitstream based on a Phase Shift Keying (PSK) signal constellation, wherein signal points of the PSK signal constellation are located on at least two rings, a first ring having a first radius r1 and a second ring having a second radius r2, wherein the first radius and second radius differ, and wherein the signal points are not located on a regular n-dimension lattice, where n is an integer, the first encoder further configured to modulate the encoded bitstream with a carrier.

15. The apparatus of claim 14 wherein the second radius is greater than the first radius, and wherein the second radius a non-integer multiple of the first ring radius.

16. The apparatus of claim 14 wherein the signal points of the signal constellation may be represented by a component on a plane, the plane having at least one axis, the axis extending from an origin in a first direction and in a second direction, wherein the signal constellation includes at least two signal points, a first point lying in the first direction and a second point lying in the second direction, wherein an amplitude of the first signal point in the first direction is greater than an amplitude of the second signal point in the second direction.

17. The apparatus of claim 14 further comprising:
a demultiplexer configured to separate the bitstream from a signal representing an optical signal to be transmitted.

18. The apparatus of claim 17 further comprising:
a receiver for decoding the optical signal.

19. A method of shaping an optical signal, the method comprising:
modulating the optical signal using a Phase Shift Keying (PSK) signal constellation having a set of signal points, wherein each of the signal points is represented by a complex number having at least a first component and a second component, wherein a first maximum amplitude of the first component of the set of signal points of the PSK signal constellation differs from a second maximum amplitude of the second component of the set of signal points of the PSK signal constellation.

20. An apparatus comprising:
a modulator for modulating an optical signal using a Phase Shift Keying (PSK) signal constellation having a set of signal points, wherein each of the signal points is represented by a complex number having at least a first component and a second component, wherein a first maximum amplitude of the first component of the set of signal points of the PSK signal constellation differs from a second maximum amplitude of the second component of the set of signal points of the PSK signal constellation.
